(19) United States
(12) Patent Application Publication
(10) Pub. No.: US 2014/0282460 A1
(43) Pub. Date: Sep. 18, 2014

(54) ENTERPRISE DEVICE UNENROLLMENT

(71) Applicant: MICROSOFT CORPORATION, Redmond, WA (US)

(72) Inventors: Zhi Cai, Redmond, WA (US); Monty Jain, Redmond, WA (US); Alexei Boudzko, Redmond, WA (US); Gunnar Kudrjavets, Kirkland, WA (US); Yuhang Zhu, Bellevue, WA (US); Daniel Kevin McBride, Redmond, WA (US); Clifford Paul Strom, Sammamish, WA (US)

(73) Assignee: Microsoft Corporation, Redmond, WA (US)

(21) Appl. No.: 13/842,051

(22) Filed: Mar. 15, 2013

(51) Int. Cl. G06F 9/445

(52) U.S. Cl. CPC G06F 8/62
USPC 717/168

(57) ABSTRACT

A method and apparatus are described for unenrolling applications, such as from a mobile device. An enterprise can be associated with one or more applications. Rather than uninstalling the applications individually, a single unenroll user interface command can be used to remove all data on the mobile device associated with the enterprise. Moreover, the applications associated with the enterprise can be uninstalled. A user's personal data on the mobile device is not affected during the unenrollment.

### BACKGROUND

An enterprise application is the term used to describe software applications that businesses use to assist in solving problems. In today's corporate environment, enterprise applications are complex, scalable, distributed, component-based, and mission-critical. They may be deployed on a variety of platforms, across corporate networks, intranets, or the Internet. They are often data-centric, user-friendly, and must meet stringent requirements for security, administration, and maintenance. Examples of enterprise applications can include a sales applications, marketing applications, business intelligence tools, project management applications, etc. In short, enterprise applications can be directed to applications that a business wants its employees to use.

As mobile devices become more prevalent, users want to use their personal devices in conjunction with business. For example, rather than users owning a business phone and a separate personal phone, users own a single phone with integrated business applications and data and personal applications and data.

A problem arises when a user decides to leave a business or becomes adverse to a business. In such a situation, it is desirable to restrict the mobile device so that business applications and data are no longer available. One option currently available is to reformat the mobile device. However, reformatting destroys both personal data and enterprise data. A more eloquent solution is needed. Otherwise, users could be unwilling to use their own mobile devices for business purposes.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A method and apparatus are described for unenrolling applications, such as from a mobile device. An enterprise can be associated with a one or more applications. Rather than uninstalling the applications individually, a single unenroll user interface command can be used to remove all data on the mobile device associated with the enterprise. Moreover, the applications associated with the enterprise can be uninstalled. A user's personal data on the mobile device is not affected during the unenrollment.

In one embodiment, applications associated with the enterprise are searched. Once one or more applications are found that have the same enterprise, data associated with the applications can be deleted. Meanwhile, data unrelated to the enterprise is preserved.

In another embodiment, the applications can also be uninstalled and any icons associated with the enterprise removed.

The foregoing and other objects, features, and advantages of the invention will become more apparent from the following detailed description, which proceeds with reference to the accompanying figures.

### BRIEF DESCRIPTION OF THE DRAWINGS

FIG. 1 is an exemplary mobile device having separate application containers for storing executable files and data.

FIG. 2 is an exemplary system wherein enterprise data can be deleted without deleting personal data during an unenrollment process.

FIG. 3 is a detailed example showing a table structure for linking an application identifier to an enterprise identification.

FIG. 4 is a flowchart of a method according to one embodiment for unenrolling an enterprise from a mobile device.

FIG. 5 is a flowchart of a method according to another embodiment for unenrolling an enterprise.

FIG. 6 is an exemplary cloud environment in which unenrollment can be used across multiple devices.

FIG. 7 is an exemplary computing environment that can store software to implement the embodiments herein.

### DETAILED DESCRIPTION

FIG. 1 is a system diagram depicting an exemplary mobile device 100 including a variety of optional hardware and software components, shown generally at 102. Any components 102 in the mobile device can communicate with any other component, although not all connections are shown, for ease of illustration. The mobile device can be any of a variety of computing devices (e.g., cell phone, smartphone, handheld computer, Personal Digital Assistant (PDA), etc.) and can allow wireless two-way communications with one or more mobile communications networks 104, such as a cellular or satellite network.

The illustrated mobile device 100 can include a controller or processor 110 (e.g., signal processor, microprocessor, ASIC, or other control and processing logic circuitry) for performing such tasks as signal coding, data processing, input/output processing, power control, and/or other functions. An operating system 112 can control the allocation and usage of the components 102 and support for one or more application programs that are separately stored in application containers 114. The application programs can include common mobile computing applications (e.g., email applications, calendars, contact managers, web browsers, messaging applications), or any other computing application. Generally, data associated with an application container is not accessible by other applications. A table 115 can be associated with the application containers 114 and associate the containers to an enterprise identification.

The illustrated mobile device 100 can include memory 120. Memory 120 can include non-removable memory 122 and/or removable memory 124. The non-removable memory 122 can include RAM, ROM, flash memory, a hard disk, or other well-known memory storage technologies. The removable memory 124 can include flash memory or a Subscriber Identity Module (SIM) card, which is well known in GSM communication systems, or other well-known memory storage technologies, such as “smart cards.” The memory 120 can be used for storing data and/or code for running the operating system 112 and the applications. Example data can include web pages, text, images, sound files, video data, or other data sets to be sent to and/or received from one or more network servers or other devices via one or more wired or wireless networks. The memory 120 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device 100 can support one or more input devices 130, such as a touchscreen 132, microphone 134, camera 136, physical keyboard 138 and/or trackball 140 and one or more output devices 150, such as a speaker 152 and a display 154. Other possible output devices (not shown) can include piezoelectric or other haptic output devices. Some devices can serve more than one input/output function. For example, touchscreen 132 and display 154 can be combined in a single input/output device. The input devices 130 can include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 112 or applications can comprise speech-recognition software as part of a voice user interface that allows a user to operate the device 100 via voice commands. Further, the device 100 can comprise input devices and software that allows for user interaction via a user's spatial gestures, such as detecting and interpreting gestures to provide input to a gaming application.

A wireless modem 160 can be coupled to an antenna (not shown) and can support two-way communications between the processor 110 and external devices, as is well understood in the art. The modem 160 is shown generically and can include a cellular modem for communicating with the mobile communication network 104 and/or other radio-based modems (e.g., Bluetooth 164 or Wi-Fi 162). The wireless modem 160 is typically configured for communication with one or more cellular networks, such as a GSM network for data and voice communications within a single cellular network, between cellular networks, or between the mobile device and a public switched telephone network (PSTN).

The mobile device can further include at least one input/output port 180, a power supply 182, a satellite navigation system receiver 184, such as a Global Positioning System (GPS) receiver, an accelerometer 186, and/or a physical connector 190, which can be a USB port, IEEE 1394 (FireWire) port, and/or RS-232 port. The illustrated components 102 are not required or all-inclusive, as any components can be deleted and other components can be added.

FIG. 2 shows an embodiment of a system for implementing an unenrollment of an enterprise from a computing device, such as a mobile device. A user can select a user interface button 210 (e.g., an icon) to initiate an unenrollment process. In the alternative, a network administrator can also initiate the unenrollment process remotely. Once selected, an application associated with the user interface button launches and obtains an enterprise identification 212 associated with the button. The application then can pass the enterprise identification 212 to a package manager 216. The package manager 216 can then use the enterprise identification 212 to search a table 220 in order to find applications associated with the enterprise identification. Additionally, the table 220 can have associated locations for data of the applications. For example, the table can include a path to the application containers. Once found, the package manager 216 can delete data associated with the applications in application containers 230, 232. Although only two application containers are shown, any number of containers can be deleted. Thus, a structure is provided to have a systematic technique for deletion of multiple applications data associated with a single enterprise, and such removal can occur through a single user action, such as selection of an icon. As shown at 240, removal of the enterprise application data in containers 230, 232, does not require removal of other data on the phone. For example, personal data 240 can remain unchanged. The package manager 216 can further uninstall the applications associated with the containers 230, 232. Finally, the package manager 216 can remove any icons associated with the enterprise. In sum, through a single UI action, the system can remove multiple applications data, uninstall the applications, and delete associated icons, all without affecting the personal data of the user. Similar functionality can occur remotely from an enterprise management source 250 which can communicate with an application associated with icon 210 in order to initiate an unenrollment.

The structure of FIG. 2 can be modified in alternative embodiments. For example, the table 220 can be associated with the enterprise application, rather than the package manager. Additionally, the enterprise application can directly delete the data in the application containers 230, 232 without using the package manager. Multiple different structures can be used depending on the desired implementation.

FIG. 3 shows a detailed embodiment of a system for unenrolling enterprise applications from a mobile device. An enterprise service 310 can be an application on a mobile device for enrolling and unenrolling enterprise applications. The enterprise service 310 can transmit an enterprise identification to a package manager 312. The package manager 312 can have an associated table 314. The table 314 can have numerous fields, three of which are shown at 320, 322, 324. Field 320 includes a plurality of application identifiers. The application identifiers 320 identify different applications stored in application containers 330, which are discussed further below. The enterprise identification field 322 includes one or more enterprise identifiers. Each enterprise identifier can be associated with one enterprise. Additionally, multiple application identifiers can have the same enterprise identifier. For example, one application related to sales for a large company and another application related to distribution for the same large company can have the same enterprise identifier. Indeed all applications on the mobile device from the same large company can have the same enterprise identifier. Field 324 is associated with a location of the application associated with the application identifier. The location can be a simple path name, for example, that points to the different application containers 330. The application containers 330 include containers 340, 342, and 344, which are associated with an enterprise. The application container 340 includes program file folders 350 and data files folders 352. Additionally, embedded somewhere in the application container 340, such as within an application, is a signed certificate including the enterprise identifier. When the application is originally installed, the enterprise identifier is extracted from the signed certificate 354 and stored in the table 314 together with the application identifier. The same is true for the other applications of containers 342 and 344. Other applications, such as shown in an application container 360, are not from an enterprise and may not include a signed certificate or may include a signed certificate but with no enterprise identification. Thus, such applications do not have an enterprise identifier in the table 314. The application containers can be designed such that each application and its associated data is not accessible by other containers. Such a structure allows deletion of the container without affecting other containers.

When removing an enterprise from a mobile device, the enterprise service 310 can send a request including an enterprise identifier as a parameter to the package manager 312. The package manager 312 can use the enterprise identifier to search the table 314 and find all application identifiers 320 that have the enterprise identifier. The package manager 312 can then send back a list of one or more application identifiers to the enterprise service 310. Once the enterprise service 310 has the application identifiers, it can send off multiple requests to the package manager 312 asking it to delete data associated with each application identifier. The enterprise service 310 can further request the package manager 312 to unenroll the applications.

FIG. 4 is a flowchart of a method for unenrolling enterprise data from a mobile device. In process block 410, a search can be made for applications installed on the mobile device related to the same enterprise. For example, an enterprise identifier can be used to search a table of applications. Such a search can be initiated in response to a single unenrollment request. In process block 420, for applications found that have the same enterprise identifier, data can be deleted associated with the applications. For example, a path to a directory where the data is located can be used to delete data associated with the applications. Thus, a directory where the application data is installed can be determined through a location field in the table of applications and then the directory can be deleted. Additionally, applications can be uninstalled in a well-known manner. In process block 430, data unrelated to the enterprise is preserved. By preserving it is meant that the data remains unchanged. Generally, it is desirable that enterprise data and applications are removed from the mobile device, while personal data unrelated to the enterprise is maintained.

FIG. 5 is a flowchart according to another embodiment for unenrolling an enterprise from a mobile device. In process block 510, a user request to unenroll an enterprise is received. The request can include an enterprise identifier. For example, an enterprise service application can have access to a stored enterprise identifier. The enterprise service application can have user interface options for unenrollment. Upon receiving a user request to unenroll, the stored enterprise identifier can be used to search for all installed applications associated with the enterprise identifier. In process block 520, in response to the unenroll request, data can be automatically deleted for applications that were found. In process block 530, one or more applications associated with the enterprise identifier can be uninstalled. In some embodiments, an icon associated with the enterprise can be removed from the user interface.

FIG. 6 illustrates a generalized example of a suitable implementation environment 600 in which described embodiments, techniques, and technologies may be implemented.

In example environment 600, various types of services (e.g., computing services) are provided by a cloud 610. For example, the cloud 610 can comprise a collection of computing devices, which may be located centrally or distributed, that provide cloud-based services to various types of users and devices connected via a network such as the Internet. The implementation environment 600 can be used in different ways to accomplish computing tasks. For example, some tasks (e.g., processing user input and presenting a user interface) can be performed on local computing devices (e.g., connected devices 630, 640, 650) while other tasks (e.g., storage of data to be used in subsequent processing) can be performed in the cloud 610.

In example environment 600, the cloud 610 provides services for connected devices 630, 640, 650 with a variety of screen capabilities. Connected device 630 represents a device with a computer screen 635 (e.g., a mid-size screen). For example, connected device 630 could be a personal computer such as desktop computer, laptop, notebook, netbook, or the like. Connected device 640 represents a device with a mobile device screen 645 (e.g., a small size screen). For example, connected device 640 could be a mobile phone, smart phone, personal digital assistant, tablet computer, or the like. Connected device 650 represents a device with a large screen 655. For example, connected device 650 could be a television screen (e.g., a smart television) or another device connected to a television (e.g., a set-top box or gaming console) or the like. One or more of the connected devices 630, 640, 650 can include touchscreen capabilities. Touchscreens can accept input in different ways. For example, capacitive touchscreens detect touch input when an object (e.g., a fingertip or stylus) distorts or interrupts an electrical current running across the surface. As another example, touchscreens can use optical sensors to detect touch input when beams from the optical sensors are interrupted. Physical contact with the surface of the screen is not necessary for input to be detected by some touchscreens. Devices without screen capabilities also can be used in example environment 600. For example, the cloud 610 can provide services for one or more computers (e.g., server computers) without displays.

Services can be provided by the cloud 610 through service providers 620, or through other providers of online services (not depicted). For example, the service providers 620 can provide a centralized solution for various cloud-based services. In one embodiment, an enterprise server 622 can be available to enroll an enterprise and unenroll the enterprise from connected devices 630, 640, 650. The enterprise server 622 can have a list of all user devices associated with a common user account. And, if a user unenrolls an enterprise from one of the devices, the server 622 can automatically unenroll the enterprise from other devices on the same user account using the techniques previously described.

FIG. 7 depicts a generalized example of a suitable computing environment 700 in which the described innovations may be implemented. The computing environment 700 is not intended to suggest any limitation as to scope of use or functionality, as the innovations may be implemented in diverse general-purpose or special-purpose computing systems. For example, the computing environment 700 can be any of a variety of computing devices (e.g., desktop computer, laptop computer, server computer, tablet computer, media player, gaming system, mobile device, etc.).

With reference to FIG. 7, the computing environment 700 includes one or more processing units 710, 715 and memory 720, 725. In FIG. 7, this basic configuration 730 is included within a dashed line. The processing units 710, 715 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 7 shows a central processing unit 710 as well as a graphics processing unit or co-processing unit 715. The tangible memory 720, 725 may be volatile memory (e.g., registers, cache, RAM), non-volatile memory (e.g., ROM, EEPROM, flash memory, etc.), or some combination of the two, accessible by the processing unit(s). The memory 720, 725 stores software 780 implementing one or more innovations described herein, in the form of computer-executable instructions suitable for execution by the processing unit(s).

A computing system may have additional features. For example, the computing environment 700 includes storage 740, one or more input devices 750, one or more output devices 760, and one or more communication connections 770. An interconnection mechanism (not shown) such as a bus, controller, or network interconnects the components of the computing environment 700. Typically, operating system software (not shown) provides an operating environment for other software executing in the computing environment 700, and coordinates activities of the components of the computing environment 700.

The tangible storage 740 may be removable or non-removable, and includes magnetic disks, magnetic tapes or cassettes, CD-ROMs, DVDs, or any other medium which can be used to store information and which can be accessed within the computing environment 700. The storage 740 stores instructions for the software 780 implementing one or more innovations described herein.

The input device(s) 750 may be a touch input device such as a keyboard, mouse, pen, or trackball, a voice input device, a scanning device, or another device that provides input to the computing environment 700. For video encoding, the input device(s) 750 may be a camera, video card, TV tuner card, or similar device that accepts video input in analog or digital form, or a CD-ROM or CD-RW that reads video samples into the computing environment 700. The output device(s) 760 may be a display, printer, speaker, CD-writer, or another device that provides output from the computing environment 700.

The communication connection(s) 770 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions stored on one or more computer-readable storage media (e.g., optical media discs, volatile memory components (such as DRAM or SRAM), or nonvolatile memory components (such as flash memory or hard drives)) and executed on a computer (e.g., any commercially available computer, including smart phones or other mobile devices that include computing hardware). Any of the computer-executable instructions for implementing the disclosed techniques as well as any data created and used during implementation of the disclosed embodiments can be stored on one or more computer-readable media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope of these claims.

We claim:

1. A method of unenrolling applications from a mobile device, comprising:
searching for applications installed on the mobile device that are related to a same enterprise;
for multiple applications found that have the same enterprise, deleting data associated with the applications; and
preserving other data on the mobile device that is unrelated to the enterprise.

2. The method of claim 1, further including uninstalling the applications associated with the enterprise.

3. The method of claim 1, wherein each application associated with the enterprise has a same enterprise identifier and searching for applications installed on the mobile device includes searching for the enterprise identifier.

4. The method of claim 1, further including determining a directory where an application is installed and wherein deleting data includes deleting the directory.

5. The method of claim 1, wherein preserving other data includes only deleting data associated with the enterprise and leaving other data unchanged.

6. The method of claim 1, further including receiving a single unenrollment request for the enterprise and uninstalling all applications associated with that enterprise.

7. The method of claim 1, further including requesting a package manager for applications associated with the enterprise and receiving a list of one or more applications together with associated application identifiers.

8. The method of claim 7, further including using the application identifiers to find locations of the applications together with the data associated with the applications.

9. The method of claim 1, wherein each application and its associated data is stored in a container that is not accessible by other applications.

10. A computer-readable storage having instructions thereon for executing a method, the method comprising:
receiving a user request to unenroll an enterprise from a mobile device, the request including an enterprise identifier;
in response to the request to unenroll, automatically deleting data associated with one or more enterprise applications located on the mobile device that are associated with the enterprise identifier; and
further including uninstalling the one or more enterprise applications in response to the request to unenroll, the one or more enterprise applications being associated with the enterprise identifier.

11. The computer-readable storage of claim 10, further including searching for each application associated with the enterprise identifier and identifying a location of the data associated with each application.

12. The computer-readable storage of claim 10, further including accessing a table using a package manager, wherein the table includes application identifiers and the enterprise identifier associated with each application identifier, if applicable.

13. The computer-readable storage of claim 12, wherein an enterprise service passes the enterprise identifier to the package manager as a parameter and receives in return a list of applications associated with the enterprise.

14. The computer-readable storage of claim 12, wherein the enterprise service passes an application identifier as a parameter to the package manager and requests the package manager to delete data associated with the application identifier.

15. The computer-readable storage of claim 10, further including obtaining a list of all application identifiers that have a same enterprise identifier.

16. The computer-readable storage of claim 10, wherein the mobile device is a mobile phone.

17. A system for unenrolling applications, comprising:
an enterprise service for receiving a request for unenrolling an enterprise associated with an enterprise identification; and
a package manager for receiving the enterprise identification from the enterprise service and for searching a table including multiple applications having the enterprise identification;
wherein the enterprise service and the package manager cooperate to delete data of one or more applications having the enterprise identification.

18. The system of claim 17, wherein the system is located on a mobile phone.

19. The system of claim 17, wherein the table includes a location of the data associated with the applications.

20. The system of claim 17, wherein data, other than the data associated with the enterprise identification, remains unaffected by deletion of the data associated with the enterprise identification.
